(19) United States
(12) Patent Application Publication
(10) Pub. No.: US 2018/0247322 A1
(43) Pub. Date: Aug. 30, 2018

(54) COMPUTER-BASED FORECASTING OF MARKET DEMAND FOR A NEW PRODUCT

(71) Applicant: International Business Machines Corporation, Armonk, NY (US)

(72) Inventors: Miao He, Beijing (CN); Hongliang Li, Beijing (CN); Changrui Ren, Beijing (CN); Lin Tang, Beijing (CN); Mingchao Wan, Beijing (CN); Xunan Zhang, Beijing (CN); Xiao Bo Zheng, Shanghai (CN)

(21) Appl. No.: 15/445,211

(22) Filed: Feb. 28, 2017

(51) Int. Cl. G06Q 30/02; G06Q 10/06

(52) U.S. Cl. CPC G06Q 30/0202; G06Q 10/067

(57) ABSTRACT

The functions and capabilities of a computer are improved by programming the computer to provide market demand forecasts for a new product that are more accurate than forecasts generated using conventional approaches. A demand forecast for a new product is generated by pairing or associating a set of one or more existing products with the new product, receiving historical sales data for the existing product, separating the historical sales data into a plurality of discrete components, constructing a respective feature-based predictive model for each of corresponding components of the plurality of discrete components, generating a corresponding prediction from each respective feature-based predictive model for each of the plurality of discrete components, and aggregating each corresponding prediction for each of the plurality of discrete components to generate the demand forecast for the new product.

### FIELD

The present invention relates to computer-based forecasting of market demand for a new product.

### BACKGROUND

Market demand for a product refers to an amount of a good or a service that a consumer is willing and able to buy per unit of time. Demand for a product can be influenced by a host of variables. Variables can have distinct or disproportionate effects on the demand for different products. Product demand can be a driver of business strategy.

Product demand can shape resource distribution within a business. Mathematical models can be used to attempt to predict growth for particular classes of products. Some businesses may employ mathematical models to proactively shape resource distribution in an attempt to efficiently meet demand Businesses use estimates of future product demand to plan for activities related to the demand Based on these estimates, businesses can adjust a host of strategic factors. Some illustrative examples of strategic factors include pricing, promotion, channel prioritization, risk mitigation, manufacturing, partner choices, sales strategy, training, marketing, and financial planning Generating reliable estimates of future demand can be a powerful tool for implementing effective business planning

### SUMMARY

The following summary is merely intended to be exemplary. The summary is not intended to limit the scope of the claims.

A computer-implemented method for forecasting a demand for a new product, in one aspect, may comprise pairing or associating a set of one or more existing products with the new product, receiving historical sales data for the set of one or more existing products, separating the historical sales data into a plurality of discrete components, constructing a respective feature-based predictive model for each of corresponding components of the plurality of discrete components, generating a corresponding prediction from each respective feature-based predictive model for each of the plurality of discrete components, and aggregating each corresponding prediction for each of the plurality of discrete components to generate an aggregate demand forecast for the new product. The generating of the aggregate demand forecast is performed by multiplying a baseline demand by a demand variation.

A computer program product for forecasting a demand for a product, in another aspect, may comprise a computer-readable storage medium having a computer-readable program stored therein, wherein the computer-readable program, when executed on a computing device including at least one processor, causes the at least one processor to pair or associate a set of one or more existing products with the new product, receive historical sales data for the set of one or more existing products, separate the historical sales data into a plurality of discrete components, construct a respective feature-based predictive model for each of corresponding components of the plurality of discrete components, generate a corresponding prediction from each respective feature-based predictive model for each of the plurality of discrete components, and aggregate each corresponding prediction for each of the plurality of discrete components to generate an aggregate demand forecast for the new product. The generating of the aggregate demand forecast is performed by multiplying a baseline demand by a demand variation.

An apparatus for forecasting a demand for a new product, in another aspect, may comprise a computing device including at least one processor and a memory coupled to the at least one processor, wherein the memory comprises instructions which, when executed by the at least one processor, cause the at least one processor to pair or associate a set of one or more existing products with the new product, receive historical sales data for the set of one or more existing products, separate the historical sales data into a plurality of discrete components, construct a respective feature-based predictive model for each of corresponding components of the plurality of discrete components, generate a corresponding prediction from each respective feature-based predictive model for each of the plurality of discrete components, and aggregate each corresponding prediction for each of the plurality of discrete components to generate an aggregate demand forecast for the new product. The generating of the aggregate demand forecast is performed by multiplying a baseline demand by a demand variation.

### BRIEF DESCRIPTION OF THE SEVERAL VIEWS OF THE DRAWINGS

The foregoing aspects and other features are explained in the following description, taken in connection with the accompanying drawings, wherein:

FIG. 1 illustrates a first exemplary computer-implemented method in accordance with one or more embodiments of the present invention.

FIG. 2 illustrates an exemplary data flow diagram for use with the exemplary method of FIG. 1.

FIG. 3 depicts a graph illustrating an exemplary variation in accordance with one or more embodiments of the present invention.

FIG. 4 depicts a graph illustrating average data during a period of time, in accordance with one or more embodiments of the present invention.

FIG. 5 depicts a graph illustrating an exemplary demand level in accordance with one or more embodiments of the present invention.

FIG. 6 illustrates a second exemplary computer-implemented method in accordance with one or more embodiments of the present invention.

FIG. 7 is a graph illustrating an exemplary estimated demand variation of a new product as a function of time.

FIG. 8 illustrates a first exemplary apparatus on which any of the methods of FIG. 1 or 6 may be performed in accordance with one or more embodiments of the present invention.

FIG. 9 is a bar graph illustrating a set of experimental results using any of the methods of FIG. 1 or 6 in accordance with one or more embodiments of the invention.

FIG. 10 illustrates an exemplary apparatus in accordance with one or more embodiments of the present invention.

FIG. 11 depicts a cloud computing environment, according to embodiments of the present disclosure; and

FIG. 12 depicts abstraction model layers, according to embodiments of the present disclosure.

### DETAILED DESCRIPTION

The functions and capabilities of a computer are improved by programming the computer to provide customized market demand forecasts for a new product that are more accurate than forecasts generated using conventional approaches. The market demand forecasts are customized by selecting a set of one or more existing products that are similar to the new product. The computer generates the customized market demand forecasts more efficiently than forecasts generated using conventional approaches. These improved, customized computer-generated market demand forecasts are qualities of some embodiments of the present invention.

As used herein, a “product” is an article or a substance, or a combination thereof, that is manufactured or refined for sale. The term “new product” may refer to a cost improvement for an existing product, an improved version of an existing product, a product line extension, a market extension, a new category entry, or a new-to-the-world product offering. The cost improvement may include introducing a reduced-cost or a reduced-price version of an existing product for an existing market. The product improvement may relate to a new, improved version of an existing product or service which is targeted to the existing market. The market extension takes an existing product or an existing service to a new market. The new category entry relates to a product and a market that are both new to a company, but the product is not new to the general market. The new-to-the-world product is a radically different product or service compared to current offerings in the existing market.

The product line extension is an incremental innovation added to an existing product line and targeted to the existing market. Product line extensions help companies to remain competitive within the marketplace in the presence of changing consumer demand, advancing technology, and new market opportunities. In many market sectors, almost half of total revenue comes from new products. Within new product sales, almost half of total revenue comes from product line extensions.

In the context of an existing product, historical data points related to the product, such as past sales figures and shipment data, can be utilized within a future demand model. Future demand models apply mathematical algorithms, autoregressive models, econometric techniques, or demand curves to historical data, so as to infer future demand for a particular product. However, new product offerings lack historical data points. Without sufficient historical data points, future demand models may not be able to construct a reliable estimate of future demand for the new product offering. For example, application of conventional econometric modeling techniques requires a substantial historical database in order to generate reliable estimates of future product demand.

Generating accurate forecasts of product demand is important for new product line extensions. Many companies launch line extensions on a frequent basis. As indicated in the foregoing paragraph, there is often no historical demand data or experience-based information to forecast the demand for the product line extension. The inability to accurately forecast demand for the product line extension oftentimes results in an unexpected stock shortage of a product, or an overstock of the product. Accurately forecasting demand enables supply chain optimization, inventory planning, and production planning

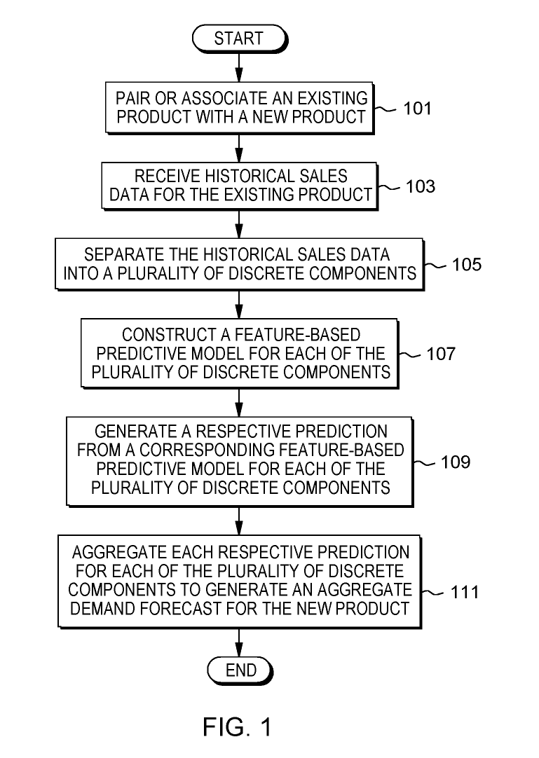

FIG. 1 illustrates an exemplary computer-implemented method in accordance with one or more embodiments of the present invention. According to this method, the functions and capabilities of a computer are improved by programming the computer to generate customized market demand forecasts for a new product that are more accurate than forecasts generated using conventional approaches. The market demand forecasts are customized by selecting a set of one or more existing products that are similar to the new product. The computer generates the customized market demand forecasts more efficiently than forecasts generated using conventional approaches. These improved, customized computer-generated market demand forecasts are qualities of some embodiments of the present invention.

The procedure commences at block 101 where a set of one or more existing products is paired with or associated with the new product. For purposes of illustration, the pairing or associating may be performed by programming a computer to identify one or more similarities between the set of one or more existing products and the new product. The pairing or associating is performed by estimating a demand pattern similarity between the new product and each of a plurality of candidate existing products to identify a first existing product that is more similar (i.e., exhibits a greater similarity) to the new product than a second existing product. The demand pattern similarity may be estimated by identifying one or more product feature similarities between the existing product and the new product.

Next, at block 103, historical sales data is received by the computer for the set of one or more existing products. Historical sales data is indicative of a level of demand for a product as a function of time. The procedure advances to block 105 where the historical sales data is separated into a plurality of discrete components. For example, the discrete components may include a baseline demand, a demand trend, a seasonality factor, and one or more impact factors such as special promotions or holiday sales. Then, at block 107, a feature-based predictive model is constructed for each of the plurality of discrete components. The procedure advances to block 109 where a respective prediction is generated from a corresponding feature-based predictive method for each of the plurality of discrete components. At block 111, each respective prediction for each of the plurality of discrete components is aggregated to generate an aggregate demand forecast for the new product. The generating of the aggregate demand forecast is performed by multiplying a baseline demand by a demand variation.

Optionally, the pairing or associating of block 101 may be performed by estimating a demand pattern similarity between the new product and each of a plurality of candidate existing products. The estimated pattern similarity is used to identify a first set of existing products each of which is more similar (i.e., exhibits greater similarity) to the new product than a second set of existing products. For each respective existing product in the first set of existing products, a corresponding demand variation is identified. A demand variation is estimated for the new product by aggregating the corresponding demand variation for each respective existing product in the first set of existing products.

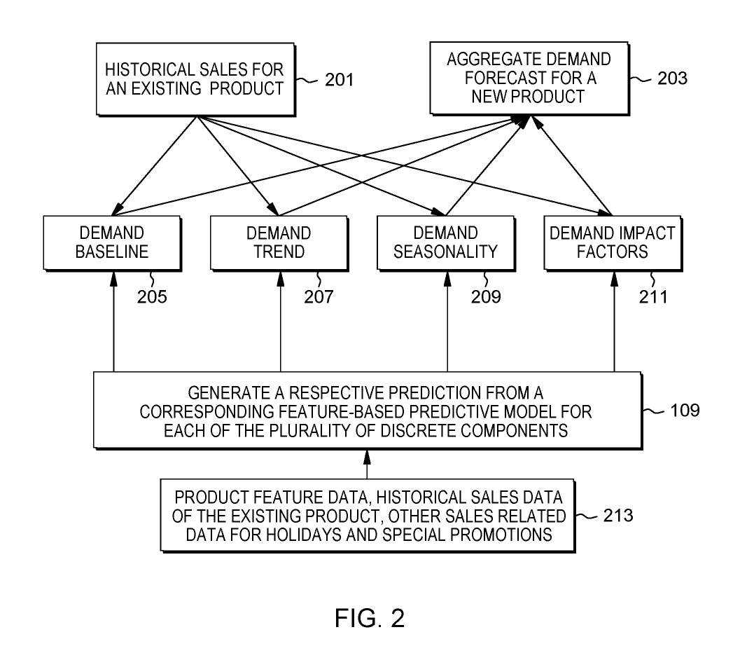

FIG. 2 illustrates an exemplary data flow diagram for use with the procedure of FIG. 1. As previously described in connection with block 105 of FIG. 1, historical sales data for the existing product 201 (FIG. 2) is separated into a plurality of discrete components which, for purposes of illustration, includes a demand baseline 205, a demand trend 207, a demand seasonality 209, and demand impact factors 211. The baseline demand 205 is a clearly defined starting point or point of departure from which implementation commences, improvement is judged, or comparison is made. For example, the clearly defined starting point could be a minimum expected or predicted level of demand based on the historical sales data. The demand trend 207 is indicative of a general direction, tendency, movement, progression, or course in which the sales data is changing as a function of time. The demand seasonality 209 is a characteristic of the historical sales data in which the data experiences regular and predictable changes that recur every calendar year. Any predictable change or pattern in a time series, such as the historical sales data, that repeats or recurs over a one-year period can be said to be seasonal. The impact factors 211 refer to any special promotion or incentive that may have influenced or affected the historical sales data.

Turning now to block 213 of FIG. 2, product feature data, historical sales data of the existing product, and other sales-related data for holidays and special promotions are inputted into the procedure of block 109 (FIGS. 1 and 2). At block 109, a respective prediction is generated from a corresponding feature-based predictive model for each of the plurality of discrete components including the demand baseline 205, the demand trend 207, the demand seasonality 209, and the demand impact factors 211 (FIG. 2).

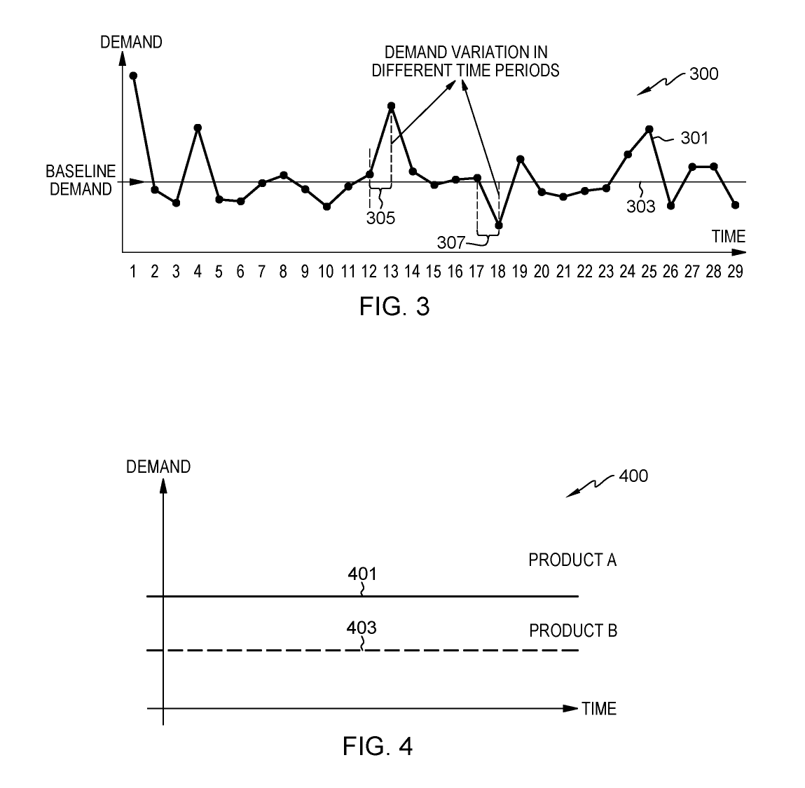

FIG. 3 is a graph 300 illustrating an exemplary variation in demand from a first time period 305 to a second time period 307. A historical level of demand as a function of time 301 can be separated or divided into different discrete components, as was previously described in connection with block 105 (FIG. 1). Returning to the example of FIG. 3, the historical level of demand as a function of time 301 may be broken down into a baseline demand 303, a demand variation in the first time period 305, and a demand variation in the second time period 307. The demand variation in the first time period 305 may be attributable to the demand trend 207 (FIG. 2), the demand seasonality 209, the demand impact factors 211, or any of various combinations thereof. Similarly, the demand variation in the second time period 307 may be attributable to the demand trend 207 (FIG. 2), the demand seasonality 209, the demand impact factors 211, or any of various combinations thereof. For purposes of illustration, the baseline demand 303 (FIG. 3) represents an average level of demand to be used as an initial basis of comparison.

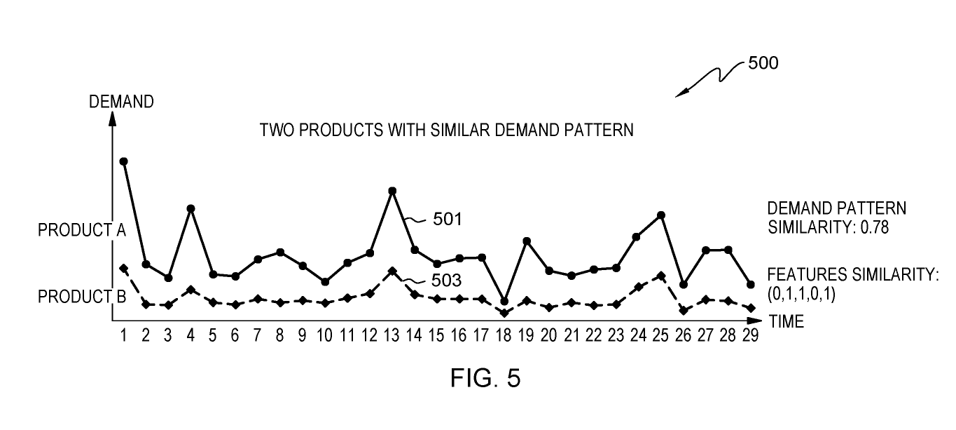

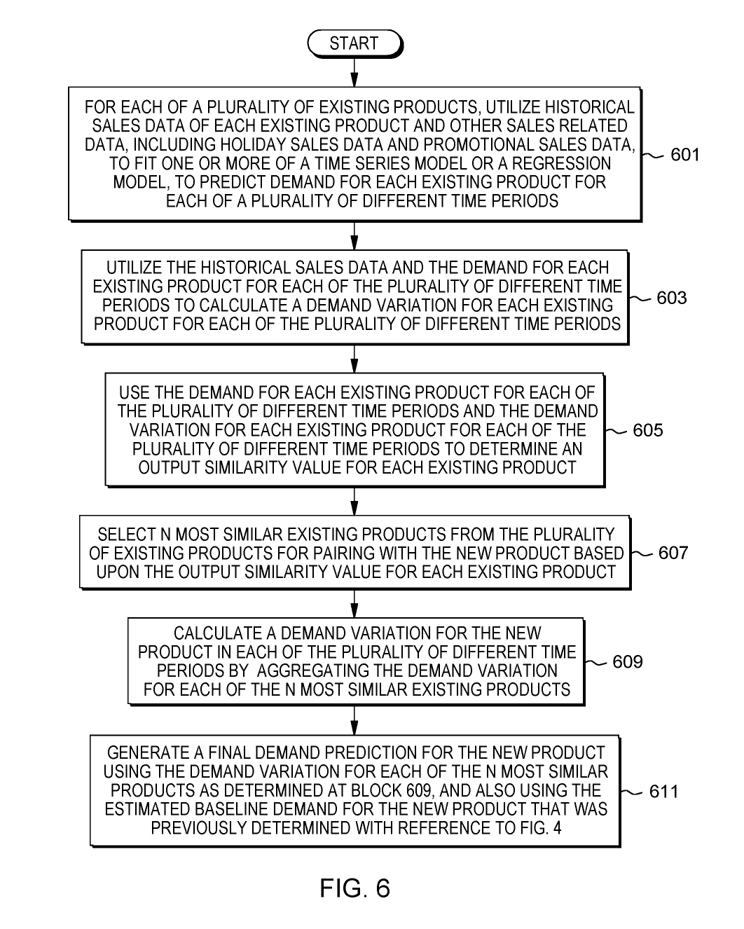

FIG. 4 is a graph 400 illustrating averaged historical sales data during a period of time for each of a plurality of products. A first demand line 401 is prepared by averaging historical sales of Product A for the period of time, and a second demand line 403 is prepared by averaging historical sales of Product B for the period of time. The first demand line 401 is indicative of a baseline level demand for a Product A for a period of time, and the second demand line 403 is indicative of a baseline level of demand for a Product B for this period of time. Product A and Product B are assumed to be existing products.

After the historical sales of these existing products are averaged for the period of time, the averaged historical sales of existing products and one or more product features are utilized to estimate a baseline demand for the new product. The estimate is generated by applying a plurality of models to the averaged historical sales of the existing products to determine a best fit model from the plurality of models. The best fit model is then used to predict the baseline demand D=f(X) for the new product, where D is product baseline demand, and X is one or more product features. Thus baseline demand can be predicted if one or more product features of the new product are given or provided. This process of predicting baseline demand uses inputs comprising historical sales data of existing products, and product features of new and existing products, to generate an output comprising the estimated baseline demand for the new product.

FIG. 5 is a graph 500 illustrating a first level of demand 501 as a function of time for a first product denoted as Product A, and a second level of demand 503 as a function of time for a second product denoted as Product B. Assume that the first product is an existing product and the second product is a new product. It may be observed that the first product and the second product exhibit similar demand patterns. Recall that, at block 101 of FIG. 1, an existing product was paired or associated with a new product. This step may be performed by identifying one or more feature similarities between the existing product and the new product. Similarities between one or more features of the new product and corresponding features of the existing product can be used to infer demand pattern similarities between the existing product and the new product. The graph 500 of FIG. 5 illustrates an example where this demand pattern similarity is present. The first level of demand 501 is representative of the existing product, and the second level of demand 503 is representative of the new product.

Optionally, the step of block 101 (FIG. 1) may include considering a plurality of candidate existing products for potential pairing with the new product. The input of this step is historical sales data for the plurality of candidate existing products, product feature data for the plurality of candidate existing products, and product feature data for the new product. The output of this step is a respective demand pattern similarity between the new product and each of the plurality of candidate existing products. In this scenario, a demand pattern similarity between a respective candidate existing product of the plurality of candidate existing products and the new product is determined. This determination is made by calculating a demand pattern similarity between each respective candidate existing product and the new product, based upon historical sales data for the respective candidate existing product. A product feature similarity between each respective candidate existing product and the new product is determined. Optionally, the pairing or associating is performed by estimating a demand variation for each of the plurality of candidate existing products from a first time period to a second time period.

When a set of candidate existing products are evaluated for potential pairing with the new product, a demand pattern similarity estimation model can be used. The demand pattern similarity estimation model is formulated using pattern similarities and feature similarities. This model is represented mathematically as S=f(X_{S}), where S is the demand pattern similarity between each respective candidate existing product and the new product, and X_{S} is the feature similarity between each respective candidate existing product and the new product. The demand pattern similarity estimation model is then applied to each of the candidate existing products and the new product to identify a candidate existing product having a best fit to the demand pattern similarity estimation model. The demand pattern similarity between each of the candidate existing products and the new product is estimated by calculating a corresponding features similarity between the new product and the respective candidate existing product.

FIG. 6 illustrates a second exemplary computer-implemented method for forecasting a demand for a new product in accordance with one or more embodiments of the present invention. The procedure commences at block 601 where, for each of a plurality of existing products, historical sales data and, optionally, other sales-related data, are used to fit one or more of a time series model, or a regression model, to predict a demand for each existing product for each of a plurality of different time periods. The procedure advances to block 603 where the historical sales data and the demand for each existing product for each of the plurality of different time periods are used to calculate a demand variation for each existing product for each of the plurality of different time periods. This demand variation Vₑₜ can be mathematically denoted as vₑₜ=yₑₜ/Dₑ, where yₑₜ is a forecasted demand of an existing product e of the plurality of existing products in a time period t, and Dₑ is a baseline demand for the existing product e.

Next, at block 605, the demand for each existing product for each of the plurality of different time periods, and the demand variation for each existing product for each of the plurality of different time periods, are used to determine a respective output similarity value for each existing product. Then N most similar existing products are selected from the plurality of existing products for pairing with the new product, based upon the respective output similarity value E_{N} for each existing product (block 607). N is a positive integer greater than zero.

A demand variation for the new product is calculated in each of the plurality of different time periods by aggregating the demand variation for each of the N most similar existing products (block 609). This step may be performed using weighted methods of other methods. Let where vₙₜ is the demand variation of the new product in a time period t, vₑₜ is the demand variation in the existing product e, and sₑ is the estimated similarity of the new product with the existing product e. The method then advances to block 611 where a final demand prediction for the new product is generated using the demand variation for each of the N most similar products as determined at block 609, and also using the estimated baseline demand for the new product that was estimated with reference to FIG. 4. Let Dₙₜ=D_{b}*Vₙₜ, where Dₙₜ is the final demand prediction for the new product in the time period t, D_{b} is the estimated baseline demand of the new product, and Vₙₜ is the estimated demand variation of the new product in the time period t.

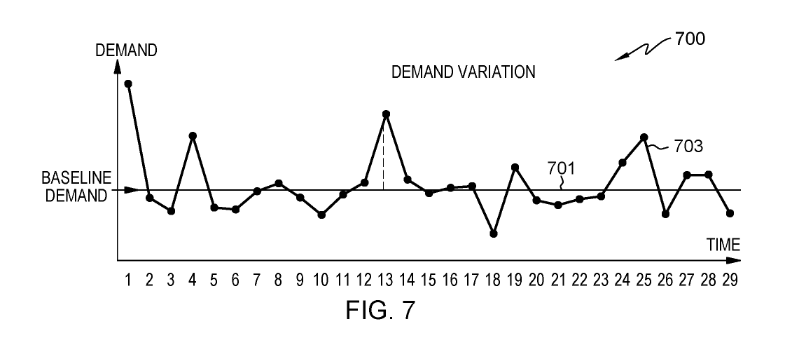

FIG. 7 is a graph 700 illustrating an exemplary estimated demand variation of the new product as a function of time. This graph 700 was prepared using the procedure of FIG. 6. The graph shows an estimated baseline demand 701 and a final demand prediction 703 for the new product as a function of time.

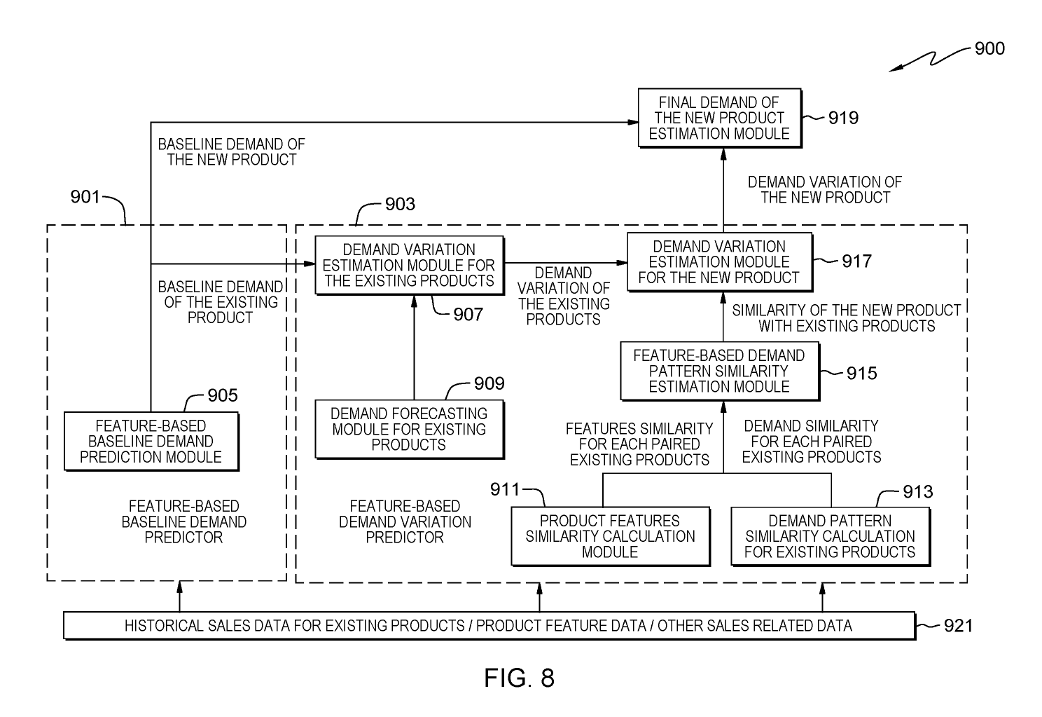

FIG. 8 illustrates a first exemplary apparatus 900 on which any of the methods of FIG. 1 or 6 may be performed in accordance with one or more embodiments of the present invention. A feature-based baseline demand predictor 901 is operatively coupled to a feature-based demand variation predictor 903. The feature-based baseline demand predictor 901 and the feature-based demand variation predictor 903 accept inputs in the form of historical sales data of existing products, product feature data, and other sales-related data 921. The feature-based baseline demand predictor 901 includes a feature-based baseline demand prediction module 905. The feature-based baseline demand prediction module 905 is programmed for generating a baseline demand for one or more existing products, and for estimating a baseline demand for the new product. The feature-based baseline demand prediction module 905 outputs the baseline demand for the new product to a final demand of the new product estimation module 919.

The baseline demand for one or more existing products, as generated by the feature-based baseline demand prediction module 905, is outputted to a demand variation estimation module for the existing products 907. The demand variation estimation module for the existing products 907 accepts an input from a demand forecasting module for existing products 909. The demand variation estimation module for the existing products 907 and the demand forecasting module for existing products 909 are both a part of the feature-based demand variation predictor 903.

The demand variation estimation module for the existing products 907 generates a demand variation of the existing products which is fed to a demand variation module for the new product 917. The demand variation estimation module for the new product 917 accepts an input from a feature-based demand pattern similarity estimation module 915 that is indicative of a similarity of the new product to one or more existing products. The feature-based demand pattern similarity estimation module 915 receives a first input from a product features similarity calculation module 911 and a second input from a demand pattern similarity calculation for existing products 913 module.

The product features similarity calculation module 911 generates a features similarity estimation for each of a plurality of paired products. The demand pattern similarity calculation for existing products 913 generates an estimated demand similarity level for each of a plurality of paired products. The demand variation estimation module for the new product 917, the feature-based demand pattern similarity estimation module 915, the product feature similarity calculation module 911, and the demand pattern similarity calculation for existing products 913, are all part of the feature-based demand variation predictor 903.

The demand variation estimation module for the new product 917 generates a demand variation of the new product. The demand variation of the new product is received by the final demand of the new product estimation module 919. The final demand of the new product estimation module 919 uses the demand variation of the new product, along with the baseline demand of the new product received from the feature-based baseline demand prediction module 905, to generate a final demand forecast for the new product.

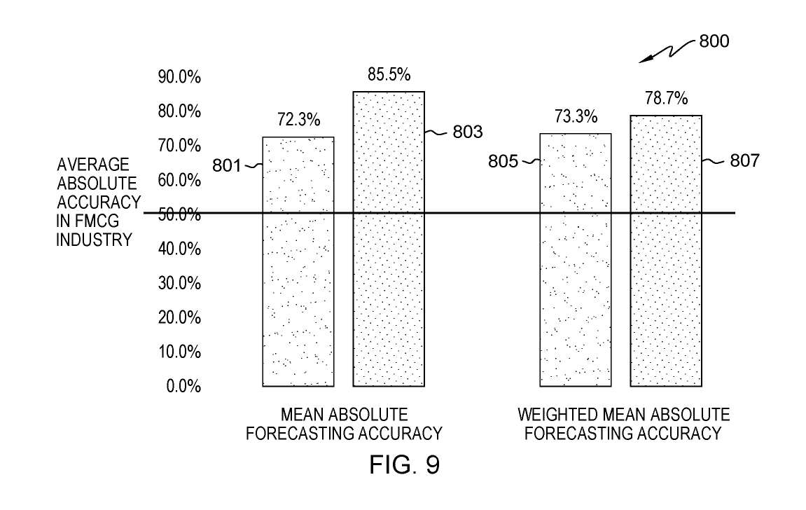

FIG. 9 is a bar graph 800 illustrating a set of experimental results using any of the methods of FIG. 1 or 6 in accordance with one or more embodiments of the invention. Pursuant to conventional methods in the field of Fast Moving Consumer Goods (FMCG), the mean absolute forecasting accuracy of new product demand forecasting is about 50%. However, with reference to a first bar 801, the mean absolute forecasting accuracy of the methods disclosed herein for new products is 72.3%. With reference to a second bar 802, the weighted mean absolute forecasting accuracy of the methods disclosed herein for new products is 73.3%. With reference to a third bar 803, the mean absolute forecasting accuracy of the methods disclosed herein for existing products is 85.5%. Likewise, with reference to a fourth bar 804, the weighted mean absolute forecasting accuracy of the methods disclosed herein for existing products is 78.7%.

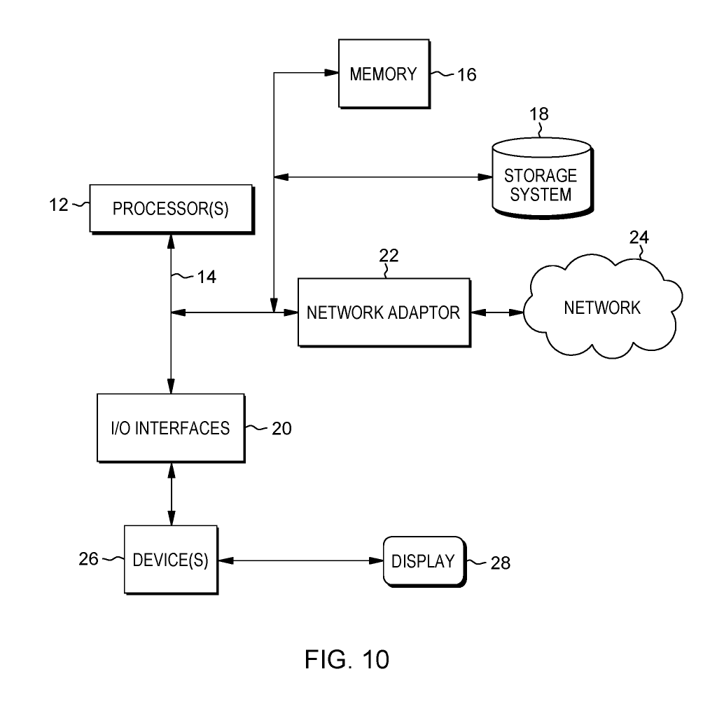

FIG. 10 illustrates an exemplary apparatus, in accordance with one or more embodiments of the present invention. This apparatus is only one example of a suitable processing system and is not intended to suggest any limitation as to the scope of use or functionality of embodiments of the present invention. The processing system shown may be operational with numerous other general-purpose or special-purpose computing systems, computing environments and/or computing configurations. Examples of well-known computing systems, environments, and/or configurations that may embody and/or be suitable for use with the apparatus shown in FIG. 10 may include, but are not limited to, personal computer systems, server computer systems, thin clients, thick clients, handheld or laptop devices, multiprocessor systems, microprocessor-based systems, neural networks, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks and/or implement particular data types. Further to the above example, the computer system may be practiced in distributed cloud computing environments, where tasks are performed by remote processing devices that are linked through a communications network. In a distributed environment, program modules may be located in both local and remote computer system storage media including memory storage devices.

The components of the computer system may include, but are not limited to, one or more processors or processing units 12, a system memory 16, and a bus 14 that couples various system components including system memory 16 to processor 12. The processor 12 may execute one or more modules (such as the aforementioned program modules) that perform one or more methods in accordance with the present invention, e.g., the example methods described with reference to FIG. 1 and/or FIG. 6. By way of further example, the module(s) may be implemented by the integrated circuits of processor 12, and/or loaded (in the form of processor-readable/executable program instructions) from system memory 16, storage device 18, network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

The computer system may also communicate with one or more external devices 26 such as a keyboard, a pointing device, a display 28, etc.; one or more devices that enable a user to interact with the computer system; and/or any devices (e.g., network card, modem, etc.) that enable the computer system to communicate with one or more other computing devices. Such communication can occur via Input/Output (I/O) interfaces 20.

Still yet, the computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with the computer system. Examples include, but are not limited to: microcode, device drivers, redundant processing units, external disk drive arrays, RAID systems, tape drives, and data archival storage systems, etc.

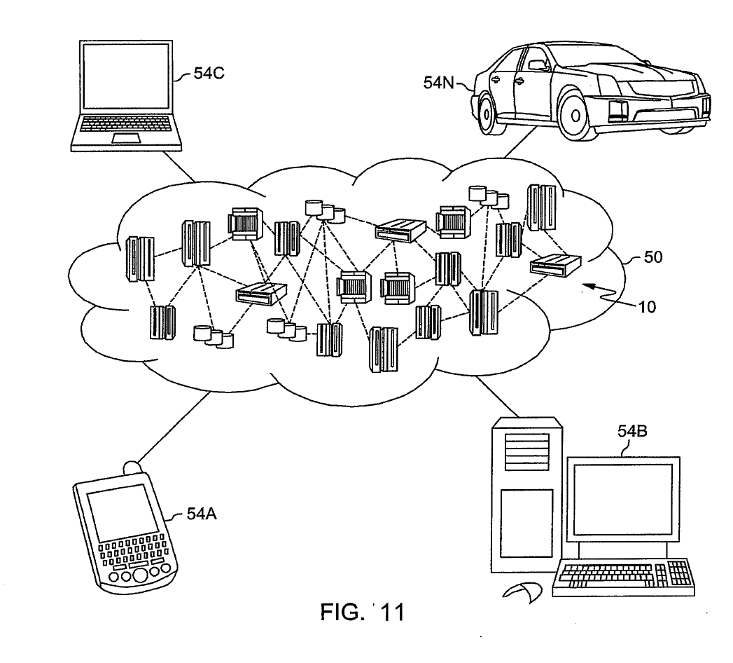

Referring now to FIG. 11, an illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 11 are intended to be illustrative only and that computing nodes 10 and cloud computing environment 50 can communicate with any type of computerized device over any type of network and/or network addressable connection (e.g., using a web browser).

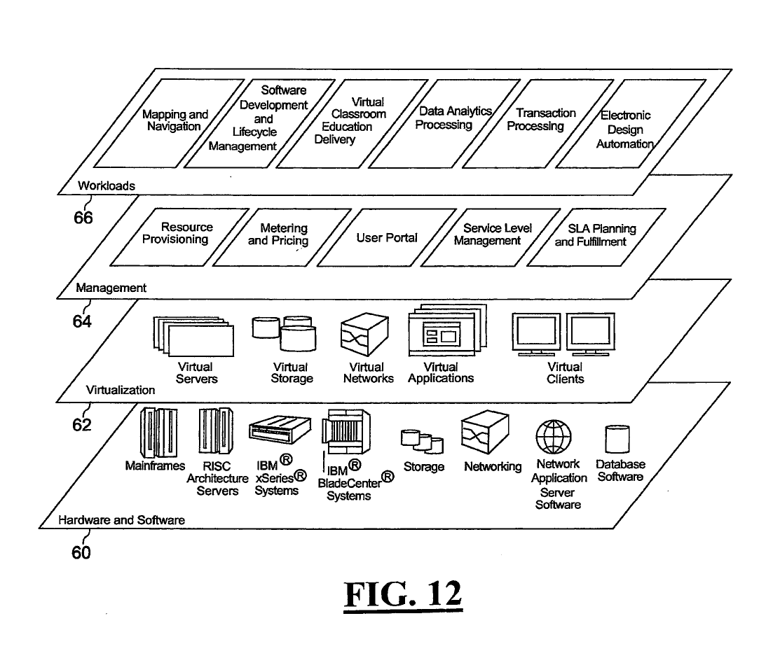

Referring now to FIG. 12, a set of functional abstraction layers provided by cloud computing environment 50 (FIG. 11) is shown. It should be understood in advance that the components, layers, and functions shown in FIG. 12 are intended to be illustrative only and embodiments of the invention are not limited thereto. As depicted, the following layers and corresponding functions are provided:

Hardware and software layer 60 includes hardware and software components. Examples of hardware components include mainframes, in one example IBM zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and electronic design automation (EDA).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method comprising:
associating, by a computer, a set of one or more existing products with a new product;
receiving by the computer, historical sales data for the set of one or more existing products;
separating by the computer, the historical sales data into a plurality of discrete components;
constructing by the computer, a respective feature-based predictive model for each of corresponding components of the plurality of discrete components;
generating by the computer, a corresponding prediction from a respective feature-based predictive model for each of the plurality of discrete components; and
generating, by the computer, an aggregate demand forecast for the new product based on the corresponding prediction, wherein the generating of the aggregate demand forecast is performed by multiplying a baseline demand by a demand variation.

2. The computer-implemented method of claim 1, wherein the associating by the computer of the set of one or more existing products with the new product, further comprises estimating, by the computer, a demand pattern similarity between the new product and one or more candidate existing products to identify a relative similarity between the new product and at least one product of the set of one or more candidate existing products.

3. The computer-implemented method of claim 2 further comprising identifying, by the computer, one or more product feature similarities between the new product and the one or more candidate existing products; wherein said estimating, by the computer, the demand pattern similarity is in response to said identifying, by the computer, one or more product feature similarities between the new product and the one or more candidate existing products.

4. The computer-implemented method of claim 2 wherein said associating, by the computer, the set of one or more existing products with the new product, further comprises estimating a demand variation for one or more of the plurality of candidate existing products from a first time period to a second time period.

5. The computer-implemented method of claim 1, wherein said associating, by the computer, the set of one or more existing products with the new product, further comprises estimating a demand pattern similarity between the new product and one or more candidate existing products; and using the demand pattern similarity to identify a first set of candidate existing products that are more similar to the new product than a second set of candidate existing products.

6. The computer-implemented method of claim 5 further comprising identifying, by the computer, a demand variation for each existing product in the first set of candidate existing products.

7. The computer-implemented method of claim 6, wherein said identifying, by the computer, further comprises aggregating the demand variation for said each respective existing product in the first set of candidate existing products.

8. The computer-implemented method of claim 1, wherein the method is provided as a service in a cloud environment.

9. A computer program product comprising a computer-readable storage medium having a computer-readable program stored therein, wherein the computer-readable program, when executed on a computing device including at least one processor, causes the at least one processor to:
associate a set of one or more existing products with a new product;
receive historical sales data for the set of one or more existing products;
separate the historical sales data into a plurality of discrete components;
construct a respective feature-based predictive model for each of corresponding components of the plurality of discrete components;
generate a corresponding prediction from a respective feature-based predictive model for each of the plurality of discrete components; and
generate an aggregate demand forecast for the new product based on the corresponding prediction, wherein the generating of the aggregate demand forecast is performed by multiplying a baseline demand by a demand variation.

10. The computer program product of claim 9, wherein the associating of the set of one or more existing products with the new product further comprises estimating a demand pattern similarity between the new product and one or more candidate existing products to identify a first existing product that is more similar to the new product than a second existing product.

11. The computer program product of claim 10, further configured for identifying one or more product feature similarities between the new product and the one or more candidate existing products; wherein said estimating of the demand pattern similarity is in response to said identifying one or more product feature similarities between the new product and the one or more candidate existing products.

12. The computer program product of claim 11, wherein the associating of the set of one or more existing products with the new product further comprises estimating a demand variation for one or more of the plurality of candidate existing products from a first time period to a second time period.

13. The computer program product of claim 9, wherein the associating of the set of one or more existing products with the new product further comprises estimating a demand pattern similarity between the new product and one or more candidate existing products; and using the demand pattern similarity to identify a first set of candidate existing products that are more similar to the new product than a second set of candidate existing products.

14. The computer program product of claim 13, further comprising identifying a demand variation for each existing product in the first set of candidate existing products.

15. The computer program product of claim 14, wherein said identifying further comprises aggregating the demand variation for said each respective existing product in the first set of candidate existing products.

16. The computer program product of claim 9, wherein the generating of the aggregate demand forecast for the new product is provided as a service in a cloud environment.

17. An apparatus comprising
at least one processor; and
a memory coupled to the at least one processor, wherein the memory comprises instructions which, when executed by the at least one processor, cause the at least one processor to:
associate a set of one or more existing products with a new product;
receive historical sales data for the set of one or more existing products;
separate the historical sales data into a plurality of discrete components;
construct a respective feature-based predictive model for each of corresponding components of the plurality of discrete components;
generate a corresponding prediction from a respective feature-based predictive model for each of the plurality of discrete components; and
generate an aggregate demand forecast for the new product based on the corresponding prediction, wherein the generating of the aggregate demand forecast is performed by multiplying a baseline demand by a demand variation.

18. The apparatus of claim 17, wherein the associating of the set of one or more existing products with the new product further comprises estimating a demand pattern similarity between the new product and one or more candidate existing products to identify a first existing product that is more similar to the new product than a second existing product.

19. The apparatus of claim 18, further configured for identifying one or more product feature similarities between the new product and the one or more candidate existing products; wherein said estimating of the demand pattern similarity is in response to said identifying one or more product feature similarities between the new product and the one or more candidate existing products.

20. The apparatus of claim 19, wherein the associating of the set of one or more existing products with the new product further comprises estimating a demand variation for one or more of the plurality of candidate existing products from a first time period to a second time period.
